(19) United States
(12) Patent Application Publication
(10) Pub. No.: US 2023/0086322 A1
(43) Pub. Date: Mar. 23, 2023

(54) STRUCTURED SILICA CLAD SILICA OPTICAL FIBERS

(71) Applicant: Biolitec Unternehmensbeteiligungs II AG, Vienna (AT)

(72) Inventors: Bolesh J. Skutnik, West Hartford, CT (US); Wolfgang Neuberger, Vienna (AT); Andrey B. Grischenko, Riga (LV)

(73) Assignee: Biolitec Unternehmensbeteiligungs II AG, Vienna (AT)

(21) Appl. No.: 17/802,495

(22) PCT Filed: Feb. 25, 2021
(86) PCT No.: PCT/IB2021/000109

§ 371 Date: Aug. 25, 2022

Related U.S. Application Data
(60) Provisional application No. 62/981,430, filed on Feb. 25, 2020.

(51) Int. Cl. H01S 3/067; H01S 3/17; C03B 37/027

(52) U.S. Cl. CPC H01S 3/06733; H01S 3/06716; H01S 3/176; C03B 37/027; C03B 2203/23; C03B 37/014

(57) ABSTRACT

A new type of all-silica optical fiber is described; a Structured Silica Clad Silica (SSCS) optical fiber, whose cladding is structured to provide mode mixing within the core; and/or to have an average effective refractive index. Its cross-section is essentially symmetrical, it can be used, among other objects, to provide flatter, more speckle-free outputs from fiber lasers, or other limited mode photonic sources. Building the new fiber structure around a rare earth doped laser core provides a better fiber laser/amplifier for cladding pumping. The structured silica cladding contains paired layers, in which a down doped silica layer is followed by a layer of pure, or lesser down-doped, or even up-dope silica, and die number of paired layers is, typically, from 5 to about 25, and, generally, within the paired layers the ratio of thickness of the higher RI layer of silicate the down-doped silica is very broad, lying between about 0.0625 to about 16, depending on the intended use of the SSCS fibers. In some versions, the main core material can be up-doped silica with pure silica or down-doped silica as the primary second component.

### INTRODUCTION

### Field of Invention

Over time photonic sources for fiber optic applications have continued to be made smaller, more compact; and increasing power density. Many medical and industrial applications are using fiber lasers and pulsed beams to provide nigh power densities for a variety of reasons, such as localizing damage, and keeping temperatures of the irradiated objects minimized to the surfaces being treated. In the process the sources have gone from large, diffuse beams to very localized few mode or single mode beams.

Now, most irradiation beam sources are highly Gaussian or even more restricted in shape, having very localized, high central peaks with relatively quick fall off of in radiation. For one-dimensional applications, such as laser cutting, this is, not a problem, but might, actually, be a benefit. However, at the atomic/molecular level such processes are multi-dimensional and may experience detrimental results. For two-dimensional, and higher applications, such as laser cleaning, welding, and machining, most cases would benefit from a broader speckle-free power distribution. Smoothing of the output to a more speckle-free distribution will benefit the application treatment. The optical fibers, disclosed herein, make such outputs much more likely, by incorporating mode mixing into their basic structure in a straight-forward manner during preform production. A new type of all-silica optical fiber is produced. As described herein. These have all the benefits of all-silica optical fibers as well as new flexibility in achieving effective Numerical Apertures and new mode carrying/mixing properties.

Furthermore, fiber lasers themselves, which are meant to be cladding pumped, would be benefited by having the laser core incorporated as the innermost core of structured silica clad optical fiber, as will be introduced herein as well.

### Background

Prior to now, all-silica optical fibers have had cladding silica around a core silica, wherein the core silica has a refractive index higher than that of the cladding silica, with a Numerical Aperture (NA) related solely to the difference in refractive index (RI) of the two materials at their interface and general optical and physical properties dependent on the specific type of silica employed in the manufacture of the preforms used to draw the optical fibers

In the past the way to create mode mixing fibers has been to break the cross-sectional symmetry of the optical fibers by introducing off center cores, using non-circular cores or introducing asymmetrical disturbances in the refractive index profile of a fiber's cross-section. There have been numerous exam Iles over the past 40 years or so of such endeavors, particularly in patents and literature on fiber lasers and/or fiber amplifiers.

The novel all-silica fibers described in the present invention, among other objects provides all-silica optical fibers which are good moue mixing fibers with symmetric cross-sections along the fiber.

### OBJECTIVES AND BRIEF SUMMARY OF THE INVENTION

A primary objective is to provide a new (novel) all-silica optical fiber structure which has a structured silica cladding, and in which the Numerical Aperture (NA) can be changed from preform to preform by varying the structure of the silica layers rather than changing doping levels within the components.

Another objective is to provide a new approach to mode mixing optical fibers, which have essentially symmetrical circular cross-sectional structures.

A further objective is to provide fiber lasers, fiber amplifiers, and the like, with improved clad pumping character, which have essentially symmetrical cross-sectional structures.

Additionally, an objective is to provide optical fibers with more speckle-free outputs with more compatible cross-sections for optical fiber transmission to remote sites.

Further, an objective is to provide a specialty fiber which can be used to join a fiber laser source to a standard optical fiber for practical treatments in medical applications.

Yet another objective is to provide a specialty optical fiber for use in industrial, or military applications which is compatible with standard optical fibers.

A new type of all-silica optical fiber is described. A Structured Silica Clad Silica (SSCS) optical fiber, whose cladding is structured to provide mode mixing in the core. Its cross-section is essentially symmetrical. It can be used to provide flatter, more speckle-free outputs from fiber lasers, or other limited mode photonic sources. Building the new fiber structure around a laser core provides a better fiber laser/amplifier for cladding pumping. The structured silica cladding contains paired layers, in which a down doped silica layer is followed by a layer of pure, or lesser down-doped, silica, and the number of paired layers is, preferably, from 5 to about 25, and, generally, within the paired layers the ratio of thickness of the pure silica to the down-doped silica is quite broad, lying between about 0.0625 to 16, depending on the intended use of the SSCS fibers. In some versions, the main core material can be up-doped silica with pure silica or down-doped silica as the second component.

### BRIEF DESCRIPTION OF DRAWINGS

In FIG. 1, the basic cross-section of the preform and drawn fiber are illustrated.

FIG. 2 presents a refractive index profile for the fiber in FIG. 1.

FIG. 3 is a cross-sectional view of a fiber with a pure lower-doped silica surrounding the basic SSCS structure.

FIG. 4 illustrates the cross-section of a new fiber laser or fiber amplifier, according to this invention.

### DETAILED DESCRIPTION OF PREFERRED EMBODIMENTS

Herein we describe a novel type of all-silica optical fiber structure, drawn from preforms with analogous internal structure. In the preform and resulting optical fiber, the cladding is composed of alternating layers of pure lower refractive index (cladding-type) material and pure higher refractive index (core-type) material, called paired layers, wherein in some examples said cladding-type layer is, commonly as thick or thicker than said core-type layer. This new cladding is called structured silica cladding (SSC) and most commonly will surround/clad a pure silica or higher index material core, giving rise to the basic SSCS structure for the optical fiber. In many examples, additional lower refractive index (RI) material will be applied over the SSC before the protective coatings/jackets are placed on the resulting optical fibers to provide more resistance to static or dynamic fatigue of all-silica optical fibers.

It is also possible for the layered silica structures to have a thicker higher index layer following a thinner lower index layer in a paired layer, which would yield structured sections having average refractive indices closer to the core, than those described above. Low refractive index differences are more beneficial in fibers preforms designed primarily as enhanced mode mixing fibers with structured silica sections within the core sections of the optical fiber/preform. The latter are described and claimed in a companion patent application, US 62/981,151, by two of the present inventors. In the associated invention, the optical fibers, having structured silica sections within a core, are either asymmetrical core or non-circular core optical fibers, which differ greatly from the symmetrical circular cross-sections of the current optical preforms and fibers, described in this invention.

The novel SSCS optical fibers provide new all-silica optical fibers much in the same manner as the Hard Clad Silica fibers discovered by one of the present inventors in the 1980s provided improved Plastic Clad Fibers. (see; U.S. Pat. No. 4,511,208, B. J. Skutnik) In the present application, the novel fibers and novel preforms from which they are drawn, provide better mode mixed outputs and the ability to create better, cladding pumped fiber lasers, fiber amplifiers, etc. among other different properties.

In SSCS fibers, besides the prior way of changing the chemical composition of the lower refractive index layer, the effective Numerical Aperture can be adjusted without changing materials. Rather, in the optical perform manufacture, the relative thickness of the lower-doped silica layer to that of the higher refractive index silica layer can change the effective refractive index of the structured silica cladding. The use of a structured silica cladding thus effectively provides an additional degree of freedom in the design of optical fibers as well as other new properties.

The number of paired layers, as well as actual thickness of the individual layers needed, depends on the evanescent field structure in specific applications and core site of the optical fiber used in the application. In some cases where the core size is small; approaching or less than 100 μm, it is beneficial if the structure of the preform and optical fiber has additional cladding material over the SSC before adding protective coatings on the drawn optical fiber. The effectiveness of the mode mixing property and cladding efficiency is also some chat dependent on the wavelengths of light used in a given application, and number of paired layers as well as thickness of individual layers within the SSC.

For ease of discussions this writeup has generally used pure Silica for the core material, (higher refractive index material) and F-doped Si as the down doped material (lower refractive index material). This invention works equally well with cores made of up-doped silica such as Ge-doped Si, as well as graded index core material. In conjunction with higher RI doped Si as core material the cladding or lower RI doped material could be pure Si.

The new fibers are able to be made with high precision as their structural features are designed carefully into the preform. In the fiber draw process generally a large draw down ratio is used which permit very well-defined layers and structures. Key to the invention is that the preform is manufactured by Plasma Vapor Deposition PVD methods, either outside vapor (POVD) or closed vapor (PCVD) methods can be used. Precise control of the vapor composition, especially, when changing between materials with different refractive indices, is crucial to form clearly defined layers within the Structured Silica Cladding section of a preform. Carefully drawing the preform using standard fiber drawing towers and techniques the optical fibers drawn will have the proportionally equivalent symmetry to that of the preform. These Structured Silica Clad Silica optical fibers are excellent for providing speckle-free output distal output for low mode, high power sources such as fiber lasers. They are also useful in the design of fiber lasers and amplifiers, with appropriate selection of innermost active cores.

Some examples of the present invention are optical fibers with large to moderate NAs to carry multimode transmissions. In these fibers the basic structure is a thicker low refractive index layer followed by a higher refractive index layer in each paired layer. Thickness ratio of the lower RI layer to the higher RI layer would be in the range of about 2 to 15. Actual thickness would depend on the conditions and capabilities of the plasma vapor deposition equipment process on hand. For most mode mixing type applications, the range for the number of paired layers would depend somewhat on the application area for the fibers, including the light sources employed. Generally, the useful number of pairs would be in the range of about 5 to 30. More preferable ranges for these parameters maybe in the range of 7 to 15 for the thickness ratio, and for about 10 to 25 for the number of paired layers.

Where an application would benefit from moderate to small NAs, the structured silica cladding would be better served by thicker high refractive index layers and thinner low refractive index layers. Using the same starting materials but changing the thickness ratios to benefit larger relative thicknesses of the higher RI layer compared to the lower RI layer in each paired layer. Optical fibers with very low NAs, as the effective refractive index of the structured silica cladding approach that of the core material, can be drawn from properly designed preforms.

Alternatively, higher RI structured silica sections can be accomplished with up-doped silica as the higher RI layer and the fluorosilicate for the lower RI layer, adjusting the relative thicknesses to achieve a very low effective NA for the fiber, as desired.

Ratios of the higher RI layer to the lower RI layer can be useful in the range of about 3 to 20. The generally useful range of number of pairs would in the range of 5 to 30. More preferable ratifies for these parameters maybe in the range of 7 to 15 for the thickness ratio, and for about 10 to 25 for the number of paired layers.

More particularly for mode mixing applications, a slightly different cross-section might benefit the situation. The addition of a thin layer onto the core material, wherein the added layer has a refractive index that is higher than that of the cote material and is followed by the normal structured silica cladding described above, starting with selected lower refractive index layer and so on. This configuration may increase the evanescent field effect and thus increase the efficiency of the mode mixing of the structured silica cladding.

In FIGS. 1 to 4 some examples having the thinner lower RI layer compared to a thicker higher RI layer within each paired layer of the structured silica cladding are depicted, as described below.

A pure silica core rod 101 was been placed in a POVD chamber to add a series of layers alternating between down-doped layer 123 and pure silica layer 121 leading to the structured section 103 seen in FIG. 1. The difference between the diameter of the pure silica core 102 and the diameter of the structured silica cladding 104 defines the overall thickness of mode-mixing, structured silica cladding 103. Within cladding 103, there are a number of layered pairs 120 which can be different for different cases, generally being in the range of 8 to 30 pairs. Within each layered pair 120, layer 121 of pure silica is often much thicker than layer 123 of down-doped silica. The range for the ratio of the two thicknesses is generally about 3 to 20. This is summarized in FIGS. 1 and 1A. Particularly useful ranges of these two parameters are 7-13 for the thickness ratio within paired layers, and 12-20 for the number of paired layers.

As a matter of course, to start with a silica core of the proper size, the inner core 101, 201, . . . may be fabricated from a thinner silica rod onto which pure silica is deposited by the plasma deposition of additional pure silica to achieve the desired core diameter in some cases.

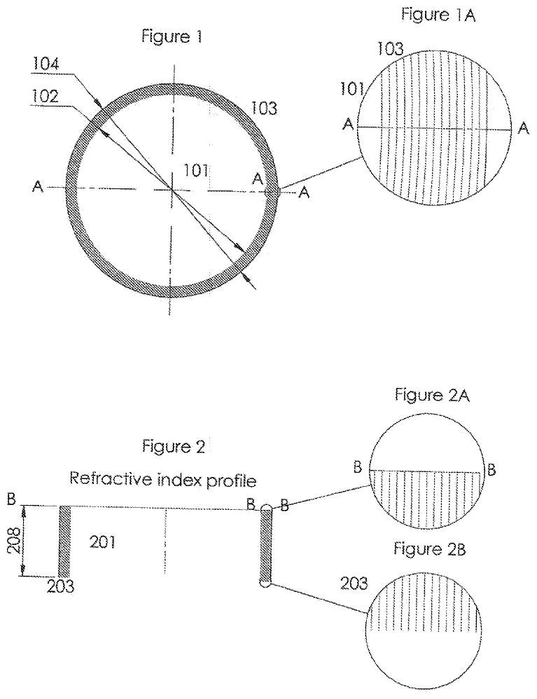

FIG. 2 illustrates a Refractive Index (RI) profile for preform 100 in cross-section. FIGS. 2A and 2B show how the RI changes across the cross-section. The lines represent the drop in refractive index for the down-doped silica layers between the refractive index of the core material. The sharpness of the change in RI demonstrates the sharp change in material during deposition, and the speckle-free bottoms establish the speckle-freeity of the dopant level in each down-doped layer. In one series of examples, the (delta) n=5×10⁻³.

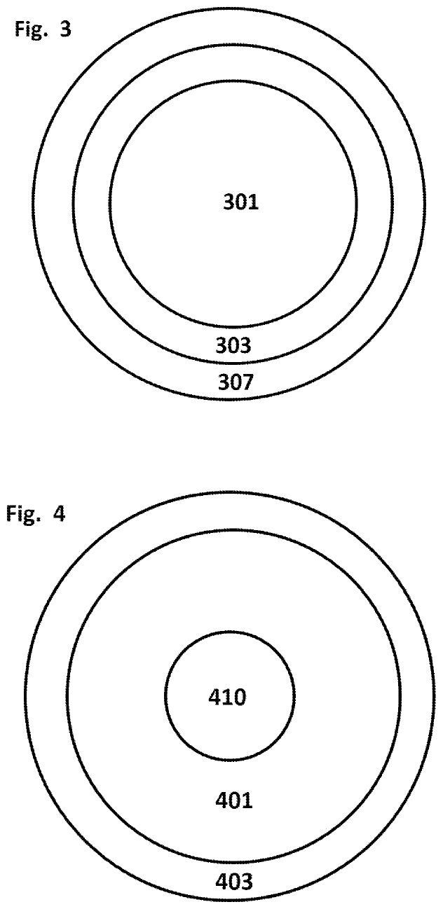

In FIG. 3, added cladding type layer 307 with a constant RI smaller than the RI of core 301 and generally the average RI of structured silica cladding 303. In the current case it would be either a Fluro-silicate deposition, deposited during preform manufacture or a plastic cladding applied during the fiber draw process to provide an extra barrier to contain the light transmitted through said SSCS optical fiber.

A sketch of the cross-section of a cladding pumped fiber laser/amplifier, according to the present invention, is shown in FIG. 4. Rare earth doped core 410 is surrounded by pure silica core/cladding 401 and ‘second’ cladding, SSC 403 surrounds the pure silica initial cladding to provide a more efficient cladding pumped device.

In summary, the structured silica cladding contains paired layers, in which, e.g., in one type of SSCS fiber, a lower refractive index layer is followed by a thinner layer of pure silica. The number of paired layers, typically, is from 3 to about 30, and, generally, within the paired layers the ratio of thickness of the lower refractive index material to that of the higher refractive index material is between 2 and 20.

In another variant of SSCS fiber, where a lower to very low effective NA is desired in the SSCS, the thicknesses within paired layers can be the same or, reversed; i.e. a thin (down-doped), lower refractive index layer is followed by a thicker higher refractive index (e.g. pure silica) material. Within the paired layers the ratio of thicknesses here is relative to the thicker higher RI layer, with ratio of higher refractive index layer to lower refractive index layer typically between 2 and 20. The number of paired layers would generally be from about 3 to 30.

In either version, the optical fiber can have a low-index polymeric material applied over the structured silica cladding, during drawing, as well as adding an outer jacket to the optical fiber for mechanical protection.

In some versions of the invention, the structured silica cladding area of the preform is further surrounded by a layer of down-doped silica or other reflective coating and a lower index material can be applied to the optical fiber, as it is drawn from a preform. All fibers generally have outermost coatings for mechanical protection in applications/use.

While pure silica (Si) is primarily envisioned as the core material and tire down-doped silica would be a fluoro-silica, other materials could also be used such as up-doped silica or a graded index silica for core material paired with pure silica as the “down-doped” material. Other down-doped silicas can also be used in place of fluoro-silica, (F—Si) depending on intended uses.

1. An optical fiber comprising a structured silica cladding with an average refractive index and a silica core with a refractive index higher than said structured silica cladding average refractive index.

2. The optical fiber according to claim 1, wherein said structured silica cladding comprises a number of paired layers of down doped silica and then a less down-doped or an up-doped or even pure silica, said less-doped, up-doped, or even pure silica layer being, typically, thinner than said down doped layer.

3. The optical fiber, according to claim 2, wherein a ratio of said down-doped layer thickness to said less down-doped silica layer thickness is between about 2 to 15.

4. The optical fiber, according to claim 2, wherein said number of paired layers is between about 2 and 30.

5. The optical fiber, according to claim 1, further comprising an outer coating, wherein said outer coating is selected from the group consisting of pure silica, a high refractive index plastic, and a down doped silica, a low refractive index plastic cladding material.

6. The optical fiber, according to claim 1, wherein within said silica core is an innermost core, doped with rare earth materials, whose refractive index is higher than said core silica, and said doped innermost core allows said optical fiber to function as a cladding pumped fiber laser or fiber amplifier.

7. A method of producing an optical fiber, according to claim 1, with a structured silica cladding and a higher refractive index silica core, which comprises; preparing a preform having a circular silica core surrounded by a section of circular layered pairs of a down doped layer followed by a generally thinner higher refractive index silica layer; and drawing said preform with standard drawing parameters to create optical fibers with selected fiber core dimensions.

8. A method of producing an optical fiber laser/amplifier, according to claim 6, with a structured silica second cladding, a silica first cladding and rare earth doped innermost core, which comprises; preparing a preform having a circular innermost rare earth doped core surrounded by a silica first cladding and then a section of circular layered pairs of a down doped layer followed by a thicker pure silica layer; and drawing said preform with standard drawing parameters to create optical fibers with selected fiber core dimensions.

9. A new subclass of all-silica optical fibers, which are particularly useful for speckle-free output even from low mode power sources, comprising: a core, having a refractive index, or refractive index profile; a structured silica cladding surrounding said core, having an average refractive index lower than said core, said structured silica cladding being composed of a number of alternating layers of differing refractive index and thickness wherein said structured silica cladding is composed of alternating layers, paired layers, of lower refractive index silica and of higher refractive index silica, and the layers have different thicknesses; and wherein a ratio of the thicknesses of the lower refractive index layer to that of the higher refractive index layer, in a given paired layer, falls within the range of 3 to 20; and the number of paired layers comprising the structured silica cladding varies from 5 to 30.

10. The optical fiber according to claim 9, wherein the ratio of thicknesses of the lower refractive index layer to the that of the higher refractive index layer is between about 7 and 15.

11. The optical fiber according to claim 9, wherein the number of paired layers is between about 10 and 25.

12. An optical fiber comprising a structured silica cladding with an average refractive index and a silica core with a refractive index higher than said structured silica cladding average refractive index.

13. The optical fiber according to claim 12, wherein said structured silica cladding comprises a number of paired layers of down doped silica and then a less down-doped or even pure silica, said less-doped or even pure silica layer being, typically, thicker than said down doped layer.

14. The optical fiber, according to claim 13, wherein a ratio of said higher refractive index silica layer thickness to said down-doped layer thickness is between about 2 to 15.

15. The optical fiber, according to claim 13, wherein said number of paired layers is between about 2 and 30.

16. The optical fiber, according to claim 12, further comprising an outer coating, wherein said outer coating is selected from the group consisting of additional pure silica, a high refractive index plastic, and a down doped silica, a low refractive index plastic cladding material.

17. The optical fiber, according to claim 12, wherein within said silica core is an innermost core, doped with rare earth materials, whose refractive index is higher than said silica core, and said doped innermost core allows said optical fiber to function as a cladding pumped fiber laser or fiber amplifier.

18. A method of producing an optical fiber, according to claim 12, with a structured silica cladding and silica core, which comprises; preparing a preform having a circular silica core surrounded by a section of circular layered pairs of a down doped layer followed by a generally thicker higher refractive index silica layer; and drawing said preform with standard drawing parameters to create optical fibers with selected fiber core dimensions.

19. A method of producing an optical fiber laser/amplifier, according to claim 17, with a structured silica second cladding, a silica first cladding and rare earth doped innermost core, which comprises; preparing a preform having a circular innermost rare earth doped core surrounded by a silica first cladding and then a section of circular layered pairs of a down doped layer followed by a thicker pure silica layer; and drawing said preform with standard drawing parameters to create optical fibers with selected fiber core dimensions.

20. A new subclass of all-silica optical fibers, which are particularly useful for speckle-free output even from low mode power sources, comprising: a core, having a refractive index, or refractive index profile; a structured silica cladding surrounding said core, having an average refractive index lower than said core, said structured silica cladding being composed of a number of alternating layers of differing refractive index and thickness wherein said structured silica cladding is composed of alternating layers, paired layers, of lower refractive index silica and of higher refractive index silica, and the layers have different thicknesses; and wherein a ratio of the thicknesses of the higher refractive index layer to that of the lower refractive index layer, in a given paired layer, falls within the range of 3 to 20; and the number of paired layers comprising the structured cladding varies from 5 to 30.

21. The optical fiber according to claim 20, wherein the ratio of thicknesses of the higher refractive index layer to the that of the lower refractive index layer is between about 7 and 15.

22. The optical fiber according to claim 20, wherein the number of paired layers is between about 10 and 25.
